(19) United States
(12) Patent Application Publication
(10) Pub. No.: US 2006/0188304 A1
(43) Pub. Date: Aug. 24, 2006

(54) Printing apparatus

(75) Inventors: Akihiko Yamazaki, Ibaraki (JP); Isao Nakajima, Ibaraki (JP); Sho Sawahata, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Ricoh Printing Systems, Ltd., Tokyo (JP)

(21) Appl. No.: 11/322,305

(22) Filed: Jan. 3, 2006

(30) Foreign Application Priority Data
Feb. 18, 2005 (JP) P2005-042196
Sep. 22, 2005 (JP) P2005-275370

(51) Int. Cl. G03G 15/00

(52) U.S. Cl. 399/384; 399/388

(57) ABSTRACT

A printing apparatus including a first component having a photosensitive member and a transcribing portion transcribing a toner image formed on the photosensitive member onto a web, and a second component having a web guide portion guiding the web transported to the transcribing portion and a fixing portion fixing the toner image transcribed onto the web, the first component and the second component being able to be connected/divided, the first component is provided with a transcribing portion base supporting the transcribing portion, the second component is provided with a web guide portion base arranged at a position opposed to the transcribing portion base supporting the web guide portion, and an adjusting member for restricting a position of the second component relative to the first component is provided between the transcribing portion base and the web guide portion base.

### BACKGROUND OF THE INVENTION

1. Field of the Invention

The present invention relates to a printing apparatus, particularly relates to a printing apparatus having a structure capable of being divided into a plurality of components.

2. Description of the Related Art

In accordance with correspondence to multicolor print or correspondence to large capacity of a recording medium, a printing apparatus causes size increase.

In case that the printing apparatus exceeds a common volume by the size increase, the printing apparatus is restricted by a width and a height of a door, a passage, an elevator or the like at an installing location. Therefore reconstruction of a building for installing the printing apparatus is needed. Also, in the case that the printing apparatus exceeds a common weight by the size increase, transporting means is limited and a number of persons are needed for operation of moving the printing apparatus.

Accordingly, a large printing apparatus is carried in to an installing location in the divided style a plurality of components, and the components are integrated at the installing location.

### SUMMARY OF THE INVENTION

JP-UM-A-58-100343 discloses the large printing apparatus that be able to divide into a plurality of components. However, positioning accuracy of JP-UM-A-58100343 is relatively coarse, therefore, it is not usable to a printing apparatus which requires high accuracy of 1 mm or less for positioning of the components such as a color printing apparatus.

According to an aspect of the invention, there is provided a printing apparatus including: a first component having a photosensitive member, a transcribing portion transcribing a toner image formed on the photosensitive member to a web, and a transcribing portion base supporting the transcribing portion; and a second component having a web guide portion guiding the web transported to the transcribing portion, a fixing portion fixing the toner image transcribed to the web; and a web guide portion base being arranged at a position opposed to the transcribing portion base, the web guide portion base supporting the web guide portion. The first and second components are able to be connected and divided. An adjusting member restricting a position of the second component relative to the first component is provided between the transcribing portion base and the web guide portion base.

According to the above-aspect, there is provided the printing apparatus capable of accurately connecting the divided components at a predetermined position.

### BRIEF DESCRIPTION OF THE DRAWINGS

These and other objects and advantages of this invention will become more fully apparent from the following detailed description taken with the accompanying drawings in which:

FIG. 1 is a front view of a printing apparatus according to an embodiment;

FIG. 2 is a front view of a first component;

FIG. 3 is a front view showing a state of confronting a second component with the first component;

FIG. 4 is a front view showing a rough adjusting state of the first component and the second component;

FIG. 5 is a front view showing a fine adjusting state of the first component and the second component;

FIG. 6 is a front view showing a fine adjusting state of the first component and the second component;

FIG. 7 illustrates explanatory views of an adjusting member, FIGS. 7A and 7B are outline side views, and FIG. 7C is a view viewing in A direction arrow mark of FIG. 7B; and

FIG. 8 is a perspective view of a total of an adjusting block.

### DESCRIPTION OF THE PREFERRED EMBODIMENTS

An embodiment of the invention will be explained in reference to the drawings as follows.

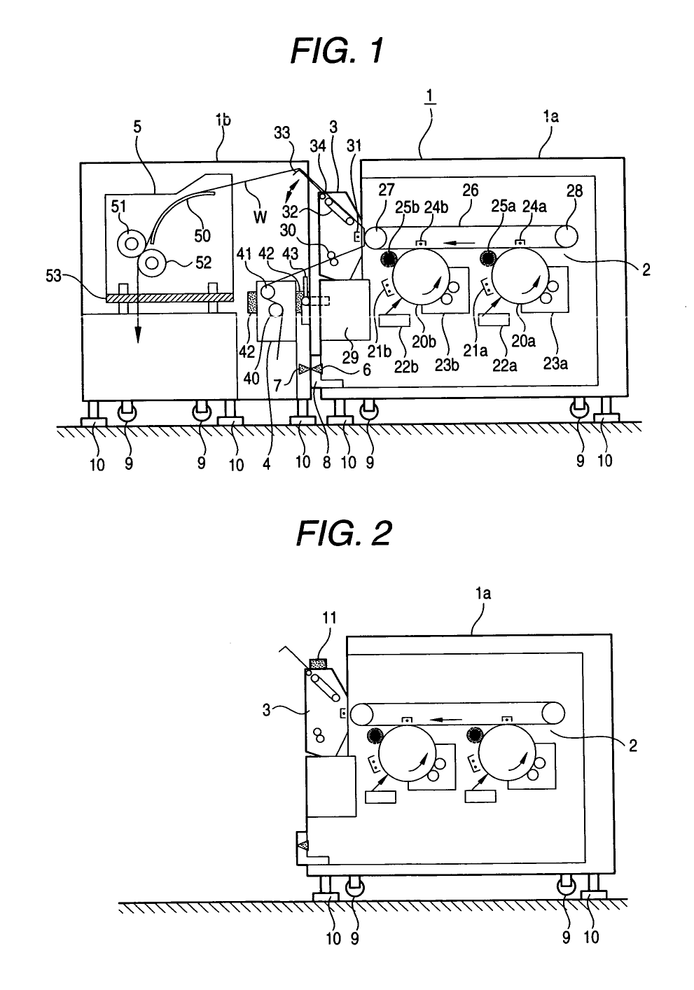

First, a total construction of a printing apparatus of the embodiment will be explained in reference to FIG. 1 by exemplifying a color laser printer. Although FIG. 1 shows a printer having two photosensitive drums in order to simplify the explanation, a full color printer using cyan, magenta, yellow and black is mounted with four of photosensitive drums. The embodiment is not limited to a color printer, and it may be a monochromatic printer mounted with a single photosensitive drum.

In FIG. 1, numeral 1 designates a laser printer which is constituted by connecting a first component 1a (hereinafter, referred to as printing component 1a)and a second component 1b (hereinafter, referred to as fixing component 1b.

The printing component 1a is mainly provided with an image forming portion 2 and a transcribing portion 3. The fixing component 1b is mainly provided with a web guide portion 4 and a fixing portion 5.

The image forming portion 2 is provided with photosensitive drums 20a, 20b, charging devices 21a, 21b, exposing device 22a, 22b, developing devices 23a, 23b, primary transcribing devices 24a, 24b, cleaning devices 25a, 25b and an intermediate transcribing belt 26.

The photosensitive drums 20a, 20b start rotating in arrow mark directions based on a print start signal from a controller (not illustrated). The photosensitive drums 20a, 20b rotate at a speed in correspondence with a printing speed of the laser printer 1 and continue to rotate until a printing operation is finished.

When the photosensitive drums 20a, 20b start rotating, a high voltage is applied on the charging devices 21a, 21b. Surfaces of the photosensitive drums 20a, 20b are uniformly charged by the charging devices 21a, 21b.

Light is irradiated from the exposing device 22a, 22b having semiconductor lasers or light emitting diodes as light source. Irradiated light exposes the photosensitive drums 20a, 20b to form an electrostatic latent image on the photosensitive drums 20a, 20b. When regions of the photosensitive drums 20a, 20b holding the electrostatic latent images reach positions where the developing devices 23a, 23b is opposed to, a developing agent is supplied to the electrostatic latent images. And toner images are formed on the photosensitive drums 20a, 20b by the developing agent.

The toner images formed on the photosensitive drums 20a, 20b are primarily transcribed onto the intermediate transcribing belt 26 by operating the primary transcribing devices 24a, 24b. The intermediate transcribing belt 26 is supported by a drive roller 27 and a driven roller 28 movably in an arrow mark direction to deliver the toner images transcribed from the photosensitive drums 20a, 20b to a side of the transcribing portion 3.

The transcribing portion 3 is installed on a transcribing portion base 29 and is provided with a pair of sheet transporting roller 30, a secondary transcribing device 31, a sheet transporting belt 32 and a buffer plate 33.

The printer of the embodiment is a printer for printing a web (normally, continuous sheet is used) which is continuously carried, and the web W is supplied from a sheet hopper (not illustrated) provided at inside of the printer, or a sheet supply apparatus (not illustrated) installed outside of the printer.

The web W is transported to between the intermediate transcribing belt 26 and the secondary transcribing device 31 by the pair of sheet transporting roller 30 via the web guide portion 4 (details of which will be described later) provided at the fixing component 1b in synchronism with timings at which the toner images formed at the intermediate transcribing belt 26 reach a secondary transcribing position.

The toner images formed on the intermediate transcribing belt 26 are secondarily transcribed onto the web W by operating the secondary-transcribing device 31.

The toner images transcribed onto the web W have not been finished to fix and therefore, it is not pertinent to use a transporting member transporting the web in contact with an image face. The web W which has passed through the secondary transcribing device 31 is transported by the sheet transporting belt 32 transporting the sheet while sucking a sheet face on a side opposed to the image face by air.

In this way, the web W is transported to the fixing portion 5 via the pair of sheet transporting roller 30, the secondary transcriber 31, the sheet transporting belt 32 and the buffer plate 33.

In the fixing component 1b, the web guide portion 4 is provided with rotating rollers 40, 41 to form a web transporting path in a substantially S-like shape. The rotating rollers 40, 41 are driven to rotate by friction with the web W drawn by the pair of sheet transporting roller 30. The web W is exerted with a predetermined tension by the web carrying path in the substantially S-like shape.

The web guide portion 4 is supported by a web guide portion base 42 provided at the fixing component 1b at a position opposed to the transcribing base 29. A portion of the web guide portion base 42 opposed to the transcribing portion base 29 is provided with an adjusting member 43 (details of which will be described later) which is used for connecting the printing component 1a and the fixing component 1b.

The fixing portion 5 is provided with a web guide 50, a heating roller 51 and a pressing roller 52. The fixing portion 5 is installed on a fixing portion base 53 provided at the fixing component 1b.

The web W transported to the fixing portion 5 is guided to a nip portion by the web guide 50. The nip portion is formed by the heating roller 51 and the pressing roller 52. The web W is nipped to be transported by the nip portion while being heated and pressed to fix the toner images onto the web W. In addition, the web guide 50 can constitute a pre-heater including a heat source that heats the web W before the nip portion.

The web W transported by the heating roller 51 and the pressing roller 52 is discharged to a sheet discharging portion provided at inside of the printer, or discharged to a post processing apparatus (not illustrated) arranged at a post stage of the printer.

The photosensitive drums 20a, 20b passing through the primary transcribing devices 24a, 24b are cleaned by the cleaning devices 25a, 25b, also the intermediate transcribing belt 26 passing through the secondary transcribing device 31 is cleaned by a cleaning device (not illustrated) for the next print operation.

In FIG. 1, numerals 6 and 7 designate marks used for adjusting heights, which are respectively provided at the printing component 1a and the fixing component 1b. Numeral 8 designates a block member formed in a substantially L-like shape positioning a position of confronting the printing component 1a and the fixing component 1b and is provided at a lower portion of the printing component 1a.

Numeral 9 designates a caster provided at a bottom face of each of the components 1a, 1b and numeral 10 designates a jack provided to be able to adjust the height.

The buffer plate 33 provided at the printing component 1a absorbs slack or excess tension of the web W which are caused by a difference between speeds of the sheet transporting belt 32 and the fixing rollers 51, 52. The buffer plate 33 is provided pivotably in an arrow mark direction by a shaft 34, and the buffer plate is pressed toward the web by an elastic member (not illustrated).

In the case that the above-described printer is configured by a single member, a volume and a weight thereof transported by one time are increased and is restricted by transporting member or the like. Hence, according to the embodiment, after finishing adjustment and inspection at a fabricating factory, the printer is temporarily divided into the printing component 1a and the fixing component 1b. The printing component 1a and the fixing component 1b are connected again after having been carried to a site (installing location of a customer).

According to the printer for forming the toner images on continuous sheet in the web-like shape, a positional relationship between the web guide portion 4 and the transcribing portion 3 and a positional relationship between the transcribing portion 3 and the fixing portion 5 are extremely important. When the three members are not positioned accurately, a sheet transporting failure, a transcribing failure and a fixing failure are brought about.

A method of connecting the printing component 1a and the fixing component 1b will be explained as follows.

An installing operation at the site is carried out first from the printing component 1a. In installing the printing component 1a, as shown by FIG. 2, a leveler 11 is mounted on the transcribing portion 3, and a horizontal level of the printing component 1a is set by adjusting the height of the jack 10 provided at the printing component 1a.

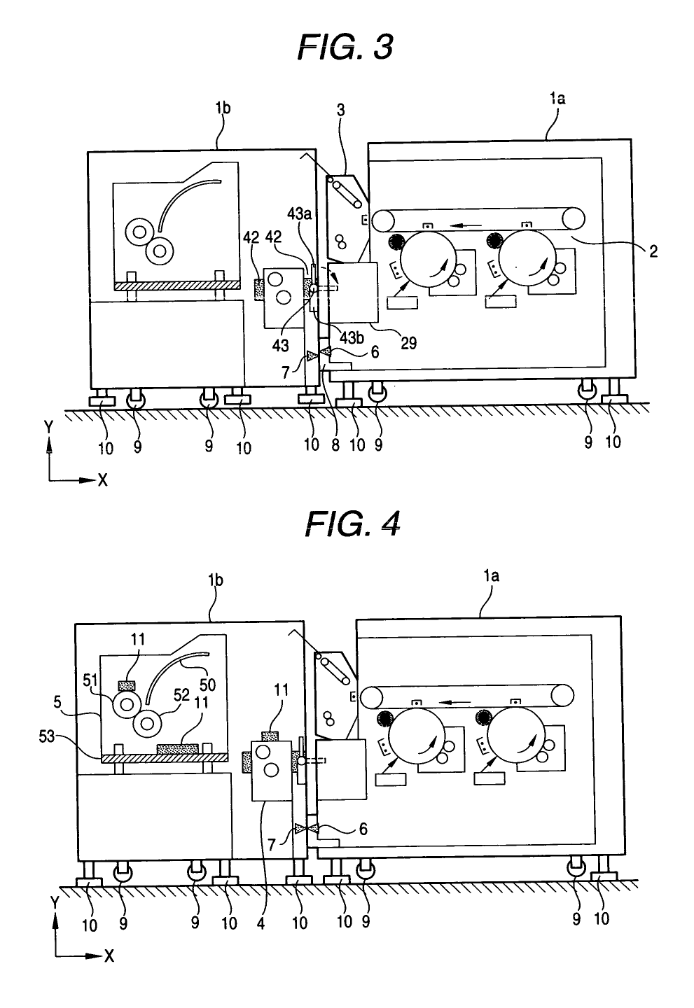

Next, as shown by FIG. 3, positioning in X direction is carried out by confronting the fixing component 1b to a vertical face of the block member 8 of the printing component 1a.

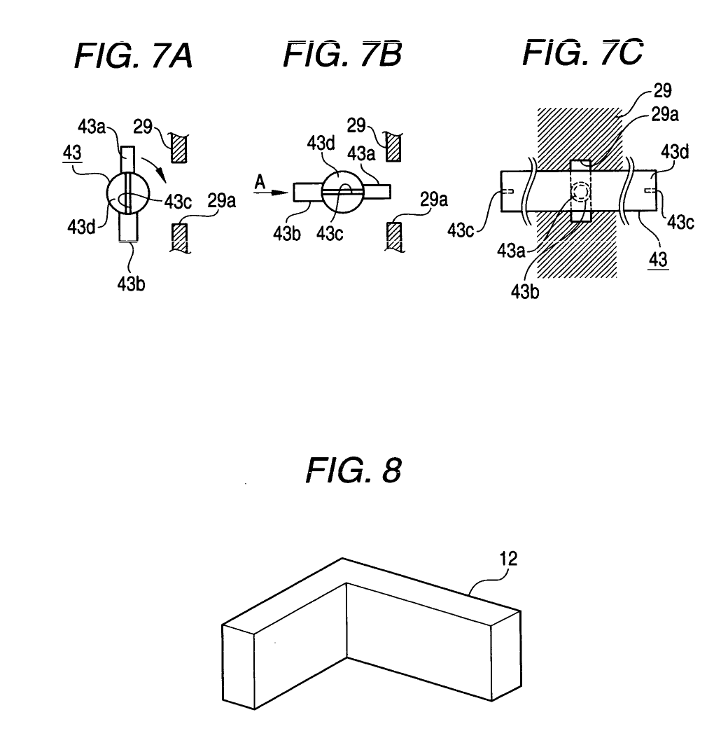

In this state, a rough adjusting pin 43a of the adjusting member 43 provided at the web guide portion base 42 is moved to a broken line position and engaged with a opening 29a (refer to FIGS. 7A-7C) to position in Z direction (direction orthogonal to paper face in FIG. 3). The web guide portion base 42 and the transcribing portion base 29 are frames for ensuring rigidities of the respective components.

As shown by FIG. 7, the adjusting member 43 is provided with the rough adjusting pin 43a and a fine adjusting pin 43b projected from an outer periphery of a rotating shaft 43d and in which the rough adjusting pin 43a or the fine adjusting pin 43b can be engaged with the opening 29a provided at the transcribing portion base 29 by inserting the end of a tool of a screw driver or the like into a groove 43c provided at a side face of the rotating shaft 43d. According to the embodiment, a width of the opening 29a is 14 mm, an outer diameter of the rough adjusting pin 43a is 10 mm and an outer diameter of the fine adjusting pin 43b is 13.9 mm.

Positioning in Y direction of the fixing component 1b confronted to the printing component 1a is carried out by adjusting the jack 10 of the fixing component 1b such that the positioning mark 7 provided at the fixing member 1b matches with the positioning mark 6 provided at the printing component 1a as shown by FIG. 4. The horizontal level is set by mounting the leveler 11 on the web guide portion 4, the fixing rollers 51, 52 and the fixing portion base 53 in combination with adjustment by the jack. Further, the levelers 11 of FIG. 4 are not necessarily three levelers simultaneously, and normally, the single leveler is used by pertinently installing the leveler at necessary-portions.

Although the components are finished to be connected by installing the printing component 1a and the fixing component 1b, with regard to positions of the transcribing portion 3, the web guide portion 4 and the fixing portion 5 relative to each other according to the embodiment, a positional shift allowable tolerance is 0.5 mm through 1 mm, and there is a case in which the positional shift cannot be restrained in the allowable range by positioning by the jack 10 and the level 11.

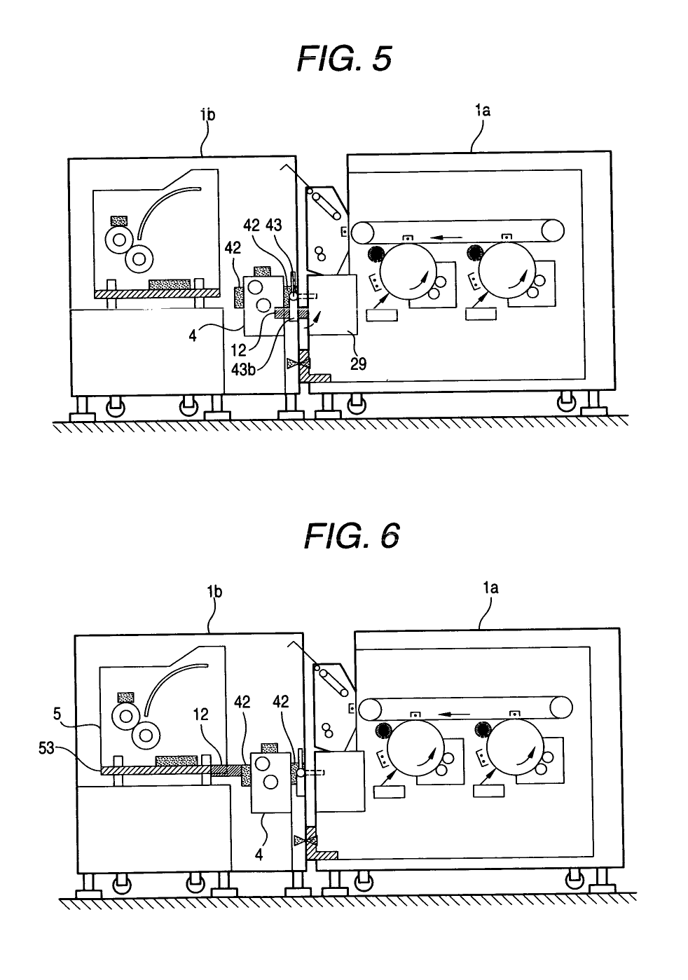

Hence, when finer adjustment is needed, after enabling to move the web guide portion 4 by loosening the web guide portion 4 from being fixed to the web guide portion base 42, as shown by FIG. 5, the fine adjusting pin 43b of the adjusting member 43 is moved to a broken line position to engage the fine adjusting pin 44b to the opening 29a to thereby carry out fine adjustment of the transcribing portion 3 and the web guide portion 4 in Z direction (direction orthogonal to paper face in FIG. 5).

Further, by positioning by interposing the adjusting block 12 between the web guide portion base 42 and the transcribing portion base 29, highly accurate positioning can be carried out. As shown by FIG. 8, the adjusting block 12 is a block member made of aluminum constituting the L-like shape, two pieces of the adjusting blocks 12 are prepared and when positioning operation, the adjusting blocks 12 are arranged at both end portions in-a longitudinal direction of the web guide portion base 42.

As shown by FIG. 6, the adjusting block 12 maybe installed between the web guide portion base 42 and the fixing portion base 53 to be used for fine adjustment of the fixing portion 5. Further, use of the adjusting block 12 is not indispensable, and there may be constructed a constitution of directly confronting the web guide portion base 42 and the transcribing portion base 29, or the web guide portion base 42 and the fixing 12 portion base 53 to position.

What is claimed is:

1. A printing apparatus comprising:
a first component having a photosensitive member, a transcribing portion transcribing a toner image formed at the photosensitive member onto a web, and a transcribing portion base supporting the transcribing portion; and
a second component having a web guide portion guiding the web transported to the transcribing portion, a fixing portion fixing the toner image transcribed onto the web to the web; and a web guide portion base being arranged at a position opposed to the transcribing portion base, the web guide portion base supporting the web guide portion,
wherein the first and second components are able to be connected and divided, and
wherein an adjusting member restricting a position of the second component relative to the first component is provided between the transcribing portion base and the web guide portion base.

2. The printing apparatus according to claim 1, wherein the adjusting member restricts a position in a depth direction of the second component relative to the first component.

3. The printing apparatus according to claim 1, wherein the adjusting member includes a pivotable pin member supported by either one base of the transcribing portion base and the web guide portion base, and
wherein the pivotable pin member is engageable with an opening provided at the other base of the transcribing portion base and the web guide portion base.

4. The printing apparatus according to claim 3, wherein the pivotable pin member includes a first pin and a second pin,
wherein the first pin has an outer diameter engageable with the opening, and
wherein a second pin has an outer diameter engageable with the opening and an outer diameter larger than the outer diameter of the first pin.

5. The printing apparatus according to claim 1, wherein the photosensitive member is a plurality of the photosensitive members.

6. The printing apparatus according to claim 1, wherein an intermediate transcribing member is provided between the photosensitive member and the transcribing portion.

7. The printing apparatus according to claim 1, wherein the web guide portion is a tension exerting portion for exerting a tension to the web transported to the transcribing portion.

8. A printing apparatus comprising:
a first component having a plurality of photosensitive members, a transcribing portion transcribing a toner image formed on the photosensitive member onto a web, and a transcribing portion base for supporting the transcribing portion; and
a second component having a web guide portion guiding the web transported to the transcribing portion, a fixing portion fixing the toner image transcribed onto the web to the web, and a web guide portion base arranged at a position opposed to the transcribing portion base for supporting the web guide portion, wherein the first component and the second component are able to be connected and divided, and
wherein an adjusting member for restricting a position in a depth direction of the second component relative to the first component is provided between the transcribing portion base and the web guide portion base.

9. The printing apparatus according to claim 8, wherein the adjusting member includes a pivotable pin member supported by either one base of the transcribing portion base and the web guide portion base, and
the adjusting member is engageable with an opening provided at the other base of the transcribing portion base and the web guide portion base.

10. The printing apparatus according to claim 9, wherein the pin member includes a first pin having an outer diameter engageable with the opening and a second pin having an outer diameter engageable with the opening and having an outer diameter larger than the outer diameter of the first pin.
